(19) United States
(12) Patent Application Publication
(10) Pub. No.: US 2023/0330725 A1
(43) Pub. Date: Oct. 19, 2023

(54) VOLATILIZATION AND OXIDATION OF ORGANIC WASTE

(71) Applicant: ANAERGIA INC., Burlington (CA)

(72) Inventors: Juan Carlos JOSSE, Aliso Viejo, CA (US); Sasha ROLLINGS-SCATTERGOOD, Fergus (CA); Kevin Carl LUTES, Guelph (CA); Devon James BARRY, Peachland (CA)

(21) Appl. No.: 18/029,466

(22) PCT Filed: Sep. 30, 2021
(86) PCT No.: PCT/CA2021/051369

§ 371 Date: Mar. 30, 2023

Related U.S. Application Data
(60) Provisional application No. 63/086,290, filed on Oct. 1, 2020.

(51) Int. Cl. B09B 3/70; F23G 7/00; C02F 11/10; C02F 11/06; C10B 53/00; B01D 53/86; B01D 53/50; B09B 3/40

(52) U.S. Cl. CPC B09B 3/70; F23G 7/001; C02F 11/10; C02F 11/06; C10B 53/00; B01D 53/8625; B01D 53/508; B09B 3/40; F23G 2201/303; F23G 2201/40; F23G 2209/26; F23G 2206/10; F23G 2209/12; F23G 2201/101; F23J 15/02

(57) ABSTRACT

In a system and process, organic waste is treated in a reactor to volatilize contaminants such as Perfluoroalkyl substances (PFAS) compounds and/or Contaminants of Emerging Concern (CECs) from the organic waste. Biochar may have reduced or undetectable PFAS compounds or CECs. Most or all of the gas may be thermally oxidized to convert PFAS compounds and/or CECs into less harmful and/or less toxic products or elemental compounds, which may be further removed. Energy may be recovered from one or more parts of the herein described system and process.

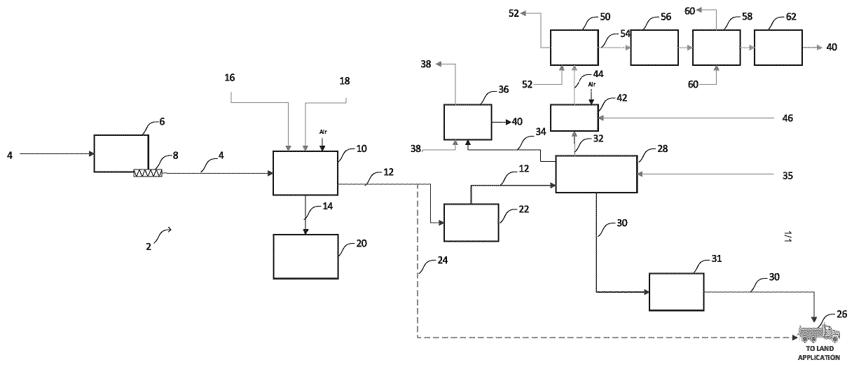

### FIELD

The present disclosure relates to treating organic waste using a volatilization process and oxidation.

### BACKGROUND

The following paragraphs are not an admission that anything discussed in them is prior art or part of the knowledge of persons skilled in the art.

Perfluoroalkyl substances (PFAS) are synthetic organofluorine chemical compounds that have fluorine atoms attached to an alkyl chain, which include well-known Perfluorooctanesulfonic acid (PFOS) and Perfluorooctanoic acid (PFOA). PFOS and PFOA are persistent organic pollutants that have been detected in humans and wildlife and are detrimental to health because of bioaccumulation in tissues. PFAS compounds play an economic role in industry due to their use in emulsion polymerization to produce fluoropolymers, and they are found in products such as stain repellents, polishes, paints, and coatings. PFAS compounds have chemical structures comprising carbonfluorine (C—F) bonds, among the strongest covalent bonds in nature, and therefore are resistant to degradation. PFAS are water-soluble and have been found in surface water, ground water, drinking water sources, wastewater treatment plant discharges and biosolids, and landfills.

Contaminants of emerging concern (CECs) are artificial organic substances that are introduced in the environment due to industrialization and manmade activity, and may cause damage to the ecosystem and human health problems. CECs include pharmaceuticals and personal care products, organic wastewater compounds, antimicrobials, antibiotics, animal and human hormones, as well as domestic and industrial detergents. Examples of CECs include ibuprofen, bisphenol A (BPA), flurosemide, naproxen, and estrogen. CECs released during their use or disposal of products containing the CECs, have been found in surface water, ground water, drinking water sources, wastewater treatment plant discharges and biosolids, and landfills. CECs also include Polychlorinated Biphenyls (PCBs), which are a group of man-made organic chemicals consisting of carbon, hydrogen and chlorine atoms. PCBs may have a detrimental effect on human health and the environment. CECs also include Polycyclic Aromatic Hydrocarbons (PAHs), which are hydrocarbons that are composed of multiple aromatic rings that occur naturally in coal, crude oil, and gasoline. PAHs are produced when coal, oil, gas, wood, garbage, and tobacco are burned. PAHs have been found in water sources and may have a detrimental effect on human health and the environment.

Due to the health and environmental concerns of PFAS and other contaminants, such as CECs, municipalities are regulating and/or may regulate the amount of PFAS and other contaminants, such as CECs, found in organic waste treatment discharges, such as wastewater treatment plant discharges.

### INTRODUCTION

The following introduction is intended to introduce the reader to this specification but not to define any of them.

Organic waste can include, for example, wastewater treatment primary or secondary sludge, biosolids, source separated organics (SSO), food waste, or the organic fraction of municipal solid waste, yard waste, industrial or commercial waste, or agricultural waste.

Organic waste may be treated by a volatilization process to extract the energy content of the organic waste. Examples of volatilization processes include pyrolysis and gasification. Pyrolysis differs from gasification in that pyrolysis is performed in the absence of oxygen whereas gasification is performed in an environment containing oxygen. Pyrolysis of organic waste produces syngas (i.e. pyrolysis gas), liquid (which may be condensed from vapor), and biochar by heating organic waste in the absence of oxygen. Pyrolysis liquid can be used as an industrial fuel to generate heat and electrical power and can be updated into transportation fuels and specialty chemicals. Syngas can be recycled into a pyrolysis process to provide process heat and supplemental fuel. Biochar produced by pyrolysis of organic waste can be used as an agricultural soil enhancement. The relative yield of products from pyrolysis may vary with temperature, for example, temperatures of 400-500 degrees C. may produce more biochar, while higher temperatures, for example up to and above 700 degrees C., may favor the yield of liquid and gaseous fuel components. In one or more known pyrolysis processes, pyrolysis liquid and/or syngas produced from pyrolysing organic waste is fed to an anaerobic digester to be used as additional feedstock for digestion and/or is used as fuel. Gasification of organic waste produces syngas, liquid (which may be condensed from vapor), and char. Similar to the above-described uses of pyrolysis products, gasification products may be used as fuel and/or soil enhancement.

The inventors have observed that, through the collection of wastewater and solid waste, the organic fractions of solid waste or biosolids contain PFAS compounds and/or other contaminants, such as CECs, at detectable levels that have known undesirable environmental impacts and/or unknown environmental impacts. Moreover, the inventors have observed that pyrolysis or gasification of organic waste under conditions that favor the extraction of energy from the organic waste and/or that favor energy recovery from the pyrolysis or gasification reaction, produced biochar or char containing PFAS compounds and/or other contaminants, such as CECs, that are higher than acceptable levels, such as levels set by local municipalities. The inventors have discovered that treating organic waste under pyrolysis or gasification conditions that favor the volatilization of at least a portion of organic waste, for example, the volatilization of most or all PFAS compounds and/or CECs, and subsequently thermally oxidizing the syngas, allows for 1) the conversion of PFAS compounds and/or CECs present in the organic waste into products that are less harmful, less toxic, and/or are valuable; and 2) energy recovery. For example, the herein described pyrolysis or gasification conditions allow for a biochar or char to be produced with: decreased concentration levels of PFAS compounds and/or CECs, concentration levels of PFAS compounds and/or CECs at below detection limits, and/or concentration levels of PFAS compounds and/or CECs below levels set by local municipalities. The herein described thermal oxidizing conditions of the syngas allow for conversion of the PFAS compounds and/or CECs into less toxic and/or less harmful compounds, such as less toxic and/or less harmful gases, which may be subsequently removed producing a flue gas with: decreased concentration levels of PFAS compounds and/or CECs, concentration levels of PFAS compounds and/or CECs at below detection limits, and/or concentration levels of PFAS compounds and/or CECs below levels set by local municipalities. The herein described process conditions of thermally oxidizing syngas produced from the volatilization of organic waste allow for energy recovery at one or more parts of the process.

In a process described herein, feedstock comprising organic waste is pyrolysed or gasified and one or more products of the pyrolysis or gasification are oxidized. The temperature of the pyrolysis or gasification may be from about 300 to about 850 degrees C. The residence time of the pyrolysis or gasification may be from about 10 to about 90 minutes. PFAS compounds and/or CECs from the organic waste may be volatilized producing a biochar or char that has a decreased PFAS compound and/or CECs content. Most or all of the syngas is oxidized to produce at least flue gas. The temperature of thermal oxidation may be from about 700 to about 1350 degrees C. The residence time of thermal oxidation may be from about 0.1 to about 10.0 seconds. PFAS compounds and/or CECs from the syngas may be converted into less harmful and/or less toxic gases, and subsequently removed from the gas, for example, by conversion into salt. Optionally, the flue gas is treated to remove additional contaminants, for example, NOx and/or SOx. Optionally, the flue gas may be used to provide energy, for example heat, for pyrolysis or gasification, and/or for drying feedstock.

An apparatus described herein has a volatilization reactor and a thermal oxidizer. The volatilization reactor may be a pyrolysis reactor or a gasification reactor. A volatilization reactor outlet is connected to an inlet of the thermal oxidizer. Optionally, the thermal oxidizer receives at least some or all the gas from the volatilization reactor. Optionally, the apparatus comprises a gas treatment unit for treating flue gas from the thermal oxidizer, for example, a NOx and/or a SOx treatment unit. Optionally, the apparatus comprises one or more heat exchangers in communication with the thermal oxidizer used to provide heat for the volatilization reactor and/or for a dryer for drying feedstock. Optionally, a heat exchanger may be included between a NOx treatment unit and a SOx treatment unit for additional heat recovery.

### BRIEF DESCRIPTION OF THE DRAWINGS

The FIGURE is a schematic drawing of an organic waste treatment system.

### DETAILED DESCRIPTION

The FIGURE shows an example of a system 2 for treating organic waste. The system 2 may be used, for example, to treat biosolids 4 from a municipal wastewater treatment plant (WWTP) (not shown). Optionally, the biosolids 4 may be pre-treated. For example, the biosolids 4 may have been separated from other waste, for example in a press or by a screen. Additionally or alternatively, the biosolids 4 may be dewatered to a high solids content, for example, about 25% TS or more, and sent to a dryer 10. Optionally, the dewatered biosolids may be stored in a dewatered biosolids storage unit 6 before being sent to a dryer 10 by, for example, a screw conveyor 8. The dryer 10 produces a dried biosolids 12 and exhaust 14. The dried biosolids 12 may have a high solids content, for example, about 90% TS, and an energy content of from about 6,500 to about 9,000 BTU/lb dry matter (DM). In some jurisdictions, some or all of the dried biosolids 12 may be a class A biosolid 24, or similarly designated biosolid 24, which may be separated and hauled offsite 26. The dryer 10 is in communication with a pyrolysis reactor 28 to send some or all of the dried biosolids 12 to pyrolysis reactor 28, for example, dryer 10 is connected directly or indirectly to pyrolysis reactor 28 by connector pipes that provide passage for dried biosolids 12. Alternatively, the dryer 10 is in communication with a gasification reactor (not shown) to send some or all of the dried biosolids 12 to the gasification reactor. The exhaust 14 may be sent to a scrubber 20, for example, a three-stage wet scrubber, to remove contaminants to meet local emissions standards. The dryer 10 may require heat, for example 20 MMBTU/hr or more, which may be provided by natural gas 16 and heat 18 recovered from the herein described system. Optionally, the dried biosolids 12 are stored in dried biosolid storage unit 22 before being sent to pyrolysis reactor 28.

The system 2 includes pyrolysis reactor 28 with an inlet to receive biosolids 4. Alternatively, the system includes a gasification reactor (not shown) with an inlet to receive biosolids 4. Preferably, the pyrolysis reactor 28 is a one-stage high temperature pyrolysis reactor powered by natural gas 35, which provides heat, for example, from about 7 to about 10 MMBTU/hr. The pyrolysis reactor 28 heats the biosolids 4 in the absence or a deficiency of oxygen, to produce biochar 30, and syngas 32. The temperature of the pyrolysis reactor 28 may be from about 300 to about 850 degrees C., for example, about 300 degrees C.; about 350 degrees C.; about 400 degrees C.; about 450 degrees C.; about 500 degrees C.; about 550 degrees C.; about 600 degrees C.; about 650 degrees C.; about 700 degrees C.; about 750 degrees C.; about 800 degrees C.; about 850 degrees C.; or from any temperature listed above to any other temperature listed above. The residence time may be from about 10 to about 90 minutes, for example, about 10 minutes; about 20 minutes; about 30 minutes; about 40 minutes; about 50 minutes; about 60 minutes; about 70 minutes; about 80 minutes; about 90 minutes; or from any time listed above to any other time listed above. In an alternative system comprising a gasification reactor, the temperature and residence time of the gasification reactor is the same as the herein disclosed temperature and residence time of the pyrolysis reactor 28.

Pyrolysis or gasification of organic waste, for example biosolids 4, at about 300 degrees C. or above and at a residence time of 10 minutes or more, volatilizes at least a portion of the organic waste 4, for example, most or all Perfluoroalkyl substances (PFAS) compounds and/or Contaminants of Emerging Concern (CECs) in the organic waste 4. This is beneficial since the produced biochar 30 or char has a reduced content of PFAS compounds and/or CECs compared to biochar or char produced in one or more known processes operating under pyrolysis or gasification conditions that favor the extraction of energy from the organic waste and/or that favor energy recovery from the pyrolysis or gasification reaction. In some examples, the biochar 30 or char has an PFAS content that meets the requirements of municipalities, such as a content level below about 6 ng/g, below about 4 ng/g, below about 3 ng/g, below about 2 ng/g, or below detection limits, or below about 2.5 ppb (PFOA) and/or below 5.2 ppb (PFOS). Fast pyrolysis, for example having a residence time of seconds, and much less than 10 minutes, may not provide sufficient thermal heat transfer to volatize most or all of the PFAS compounds and/or CECs in the organic waste 4. Optionally, the biochar 30 or char may be used as a soil enhancer typically after being collected and stored in a char storage unit 31, and then hauled off site 26. The biochar 30 or char may have an energy content, for example, of about 4700 BTU/lb DM.

Optionally, burner exhaust 34 from the pyrolysis reactor 28 or a gasification reactor is sent to a heat exchanger 36 to produce recovered heat 38 and cooled exhaust 40. The pyrolysis reactor 28 may be in thermal communication with heat exchanger 37, for example, by being directly or indirectly connected to heat exchanger 37 by connector pipes that provide passage for burner exhaust. The recovered heat 38 may be used to heat air for dryer 10, for example, by heating fluid such as air, water, or thermal oil that is sent to the dryer 10. The heat exchanger 38 may be in thermal communication with dryer 10, for example, by being directly or indirectly connected to dryer 10 by connector pipes providing passage for heated fluid. The recovered heat 38 may provide energy to the dryer 10, for example, from about 1 to about 3 MMBTU/hr.

Most or all of the syngas 32 or the pyrolysis or gasification products excluding the biochar 30 or char, is sent to a thermal oxidizer 42 having an inlet to receive the syngas 32. The thermal oxidizer 42 heats and oxidizes the syngas 32 to produce oxidizer exhaust (or flue gas) 44 comprising carbon dioxide, water vapor, and hydrogen fluoride. In some examples, the oxidizer exhaust 44 may also comprise oxidized sulfur compounds, oxidized nitrogenous compounds, and/or oxidized chlorinated compounds. Optionally, the thermal oxidizer is supplemented by natural gas 46, which provides additional heat for destruction of flue gas, for example, from about 2 to about 6 MMBTU/hr. The temperature of the thermal oxidizer 42 may be from about 700 to about 1350 degrees C., for example, from about 850 to about 1250 degrees C.; about 700 degrees C.; about 750 degrees C.; about 800 degrees C.; about 850 degrees C.; about 900 degrees C.; about 950 degrees C.; about 1000 degrees C.; about 1050 degrees C.; about 1100 degrees C.; about 1150 degrees C.; about 1200 degrees C.; about 1250 degrees C.; about 1300 degrees C.; about 1350 degrees C.; or from any temperature listed above to any other temperature listed above. The residence time may be from about 0.1 to about 10.0 seconds, for example, from about 5.0 to about 10 seconds; from about 0.1 to about 4.0 seconds; about 0.1 seconds; about 0.5 seconds; about 1.0 seconds; about 1.5 seconds; about 2.0 seconds; about 2.5 seconds; about 3.0 seconds; about 3.5 seconds; about 4.0 seconds; about 4.5 seconds; about 5.0 seconds; about 5.5 seconds; about 6.0 seconds; about 6.5 seconds; about 7.0 seconds; about 7.5 seconds; about 8.0 seconds; about 8.5 seconds; about 9.0 seconds; about 9.5 seconds; about 10.0 seconds; or from any time listed above to any other time listed above. Residence times more than about 10.0 seconds may be undesirable, for example, because the flowrate may create oxidation stages that are too large for economic purchase. Commercial thermal oxidizer units are available, for example, oxidizers capable of producing low NOx flue gas. The thermal oxidizer 42 may be a 3-stage low NOx thermal oxidizer. The first stage of the 3-stage oxidizer is performed at a high temperature, for example, from about 1093 to about 1315 degrees C., or about 1232 degrees C., and sub-stoichiometric air to dissociate nitrogen in the syngas 32 to N₂. The second stage is a quench stage. The third stage is a re-oxidation stage with excess oxygen for complete combustion and destruction of the syngas 32. The 3-stage low NOx thermal oxidizer can reach temperatures of from about 850 to about 982 degrees C. The 3-stage low NOx thermal oxidizer may be preferably, for example when producing low NOx flue gas that can be handled with a post thermal oxidizer selective catalytic reduction (SCR) to remove NOx to limits acceptable for flue gas discharge, is desirable. Using burners other than those herein described to clean syngas in its gaseous state may be more expensive and less efficient.

The herein described thermal oxidization of syngas 32 converts most or all of the PFAS compounds and/or CECs into less harmful and/or less toxic compounds, such as gases, which may be further converted into corresponding salts. For example, under the herein described thermal oxidation conditions, PFAS compounds may be converted into hydrogen fluoride (HF), which may be converted into hydrofluoric acid with the addition of water. The flue gas may be fed to a SOx scrubber, which uses a caustic scrubber (for example, NaOH or potassium hydroxide). The fluoride ions in the water may react with Na+ or K+ ions and form sodium fluoride salt or potassium fluoride salt. This is beneficial since the resulting flue gas, and subsequently produced salt, is less harmful and/or less toxic than PFAS compounds and/or CECs, and may be removed from the oxidizer exhaust 44 resulting in an exhaust that may meet required municipality levels of fluorine compounds and/or CECs. Sending most or all of the syngas 32, or the pyrolysis or gasification products excluding the biochar 30 or char, to a thermal oxidizer 42 for removing or destroying PFAS compounds and/or CECs may be more energy efficient than one or more known processes that remove PFAS compounds and/or CECs from organic waste because in the herein described process, the biochar 30 or char contains little to no PFAS compounds and/or CECs and therefore does not require further treatment to remove PFAS compounds and/or CECs.

Optionally, the oxidizer exhaust 44 from the thermal oxidizer 42 is sent to a heat exchanger 50 to produce recovered heat 52 and cooled oxidizer exhaust 54. The thermal oxidizer 44 may be in thermal communication with heat exchanger 50, for example, by being directly or indirectly connected to heat exchanger 50 by connector pipes that provide passage for oxidizer exhaust 44. The recovered heat 52 may be used to heat air for dryer 10, for example, by heating fluid such as air, water, or thermal oil that is sent to the dryer 10. The heat exchanger 50 may be in thermal communication with dryer 10, for example, by being directly or indirectly connected to dryer 10 by connector pipes providing passage for heated fluid. The recovered heat 52 may provide heat to the dryer 10, for example, from about 12 to about 30 MMBTU/hr. In some examples, the oxidizer gas 44 is sent to heat exchanger 37, which is in thermal communication with pyrolysis reactor 28 or alternatively, a gasification reactor. Sending most or all of the syngas 32, or the pyrolysis or gasification products excluding the biochar 30 or char, to a thermal oxidizer 42 and recovering energy from the oxidizer exhaust 44 may be beneficial over processes that recover energy from the syngas 32 because more energy may be recovered from the higher temperature oxidizer exhaust 44 compared to the lower temperature syngas 32. Moreover, the process of heating syngas 32 subsequent to pyrolysis or gasification and extracting energy from the oxidizer exhaust 44 may be a more efficient energy recovery process than recovering energy from the syngas subsequent to pyrolysis or gasification and then heating the cooled syngas 32 during thermal oxidation before extracting additional energy from the oxidizer exhaust 42.

Optionally, the oxidizer exhaust 44 may be passed in counterflow with the biosolids in a double wall (tube within furnace) pyrolysis reactor 28 or alternatively, a gasification reactor, to supply heat indirectly for pyrolysis or gasification, for example, without the flue gas contacting the biosolids.

Optionally, the oxidizer exhaust 44 may be treated in one or more gas treatment units, for example, a NOx gas treatment unit 56 and a SOx gas treatment unit 62, to meet local emission requirements. The thermal oxidizer 42 may be in communication with the one or more gas treatment units, for example, by being directly or indirectly connected to the one or more gas treatment units by connector pipes that provide passage for oxidizer exhaust 44. The NOx gas treatment unit 56 may comprise selective catalytic reduction (SCR) technology, and the SOx gas treatment unit 62 may comprise a caustic scrubber. Blow down from the wet caustic scrubber may contain sodium fluoride, sodium sulfite and sodium bisulphate, and can be sent to a WWTP (not shown). Optionally, exhaust from the NOx treatment unit 56 may be sent to a heat exchanger 58 to produce received heat 60 and cooled NOx treated exhaust. The exhaust from the NOx treatment unit 56 may be in thermal communication with heat exchanger 58, for example, by being directly or indirectly connected to heat exchanger 58 by connector pipes that provide passage for NOx treatment unit exhaust. The recovered heat 60 may be used to heat air for dryer 10, for example, by heating air, water, or thermal oil that is sent to the dryer 10. Optionally, oxidizer gas 44 is sent to heat exchanger 37, which is in thermal communication with pyrolysis reactor 28 or alternatively, a gasification reactor. The recovered heat 52 may provide heat to the dryer 10, for example, from about 0.5 to about 1.5 MMBTU/hr.

### EXAMPLES

### Example 1

In an example of a system 2 as described above, dewatered biosolids 4 from an anaerobic digestion system available from Anaergia under the OMNIVORE trademark, had a solids content of 25% TD, a VS/TS of 62% and an energy content of 6,940 BTU/lb DM. The dewatered biosolids 4 (71,900 gallons per day (GPD) or 299 short tonnes per day (TPD)) was sent to a 360 cubic yard cake storage unit 6. Screw conveyor 8 was used to transfer the biosolids 4 from the storage unit 6 to dryer 10, which had a drying capacity of 9 short tonnes per hour (TPH) and a heat demand of 30.4 MMBTU/hr. Natural gas provided 12.6 MMBTU/hr and recovered heat from the system 2, as described below, provided 17.8 MMBTU/hr. The dryer 10 produced dried biosolids having a solids content of 90% TS, and dryer exhaust 14, which was sent to a three-stage scrubber 20.

The dried biosolids 12 (83 TPD) was sent to dried biosolids storage 22 before being sent to pyrolysis reactor 28. The pyrolysis reactor 28 had a pyrolysis capacity of 3.5 TPH, and produced syngas 32, biochar 30, and burner exhaust 34. Natural gas provided 8 MMBTU/hr of heat to the pyrolysis reactor 28. Produced biochar 30 (37.5 TPD) had a solids content of 100% TS, an energy content of 4,782 BTU/lb DM, and a reduced content of PFAS compounds and/or CECs. The biochar 30 was stored in a 250 cubic yard storage unit 31, and then hauled off site 26.

The burner exhaust 34 was sent to heat exchanger 36, which provided 2 MMBTU/hr of heat to air 38 from the dryer 10 that flowed through the heat exchanger 36 and returned to the dryer 10. Cooled burner exhaust 40 was sent to a stack.

The syngas 32 was sent to thermal oxidizer 42. The thermal oxidizer 42 produced oxidizer exhaust 44 comprising carbon dioxide, water vapor, and hydrogen fluoride. The oxidizer exhaust 44 was sent to heat exchanger 50, which provided 15 MMBTU/hr of heat to oil 52 from the dryer 10 that flowed through the heat exchanger 50 and returned to the dryer 10. Cooled oxidizer exhaust 54 was sent to a NOx treatment unit 56. Following NOx treatment, the treated exhaust was sent to heat exchanger 58, which provided 0.8 MMBTU/hr of heat to water 60 from the dryer 10 that flowed through the heat exchanger 58 and returned to the dryer 10. Cooled treated exhaust was sent to SOx treatment unit 62, and following treatment, the exhaust 40 was sent to a stack.

### Example 2

In another example of a system 2 as described above, dewatered biosolids 4 from an anaerobic digester digestate that was hydrolyzed, had a solids content of 30% TD, a VS/TS of 60% and an energy content of 6,720 BTU/lb DM. The dewatered biosolids 4 (55,500 gallons per day (GPD) or 232 short tonnes per day (TPD)) was sent to a 360 cubic yard cake storage unit 6. Screw conveyor 8 was used to transfer the biosolids 4 from the storage unit 6 to dryer 10, which had a drying capacity of 6.4 short tonnes per hour (TPH) and a heat demand of 21.8 MMBTU/hr. Natural gas provided 6.6 MMBTU/hr and recovered heat from the system 2, as described below, provided 15.2 MMBTU/hr. The dryer 10 produced dried biosolids having a solids content of 90% TS, and dryer exhaust 14, which was sent to a three-stage scrubber 20.

The dried biosolids 12 (77 TPD) was sent to dried biosolids storage 22 before being sent to pyrolysis reactor 28. The pyrolysis reactor 28 had a pyrolysis capacity of 3.5 TPH, and produced syngas 32, biochar 30, and burner exhaust 34. Natural gas provided 7.45 MMBTU/hr of heat to the pyrolysis reactor 28. Produced biochar 30 (37.5 TPD) had a solids content of 100% TS, an energy content of 4,782 BTU/lb DM, and a reduced content of PFAS compounds and/or CECs. The biochar 30 was stored in a 250 cubic yard storage unit 31, and then hauled off site 26.

The burner exhaust 34 was sent to heat exchanger 36, which provided 1.8 MMBTU/hr of heat to air 38 from the dryer 10 that flowed through the heat exchanger 36 and returned to the dryer 10. Cooled burner exhaust 40 was sent to a stack.

The syngas 32 was sent to thermal oxidizer 42. The thermal oxidizer 42 produced oxidizer exhaust 44 comprising carbon dioxide, water vapor, and hydrogen fluoride. The oxidizer exhaust 44 was sent to heat exchanger 50, which provided 12.7 MMBTU/hr of heat to oil 52 from the dryer 10 that flowed through the heat exchanger 50 and returned to the dryer 10. Cooled oxidizer exhaust 54 was sent to NOx treatment unit 56. Following NOx treatment, the treated exhaust was sent to heat exchanger 58, which provided 0.7 MMBTU/hr of heat to water 60 from the dryer 10 that flowed through the heat exchanger 58 and returned to the dryer 10. Cooled treated exhaust was sent to SOx treatment unit 62, and following treatment, the exhaust 40 was sent to a stack.

### Example 3

In another example of a system 2 as described above, dewatered biosolids 4 from undigested sludge, had a solids content of 25% TD, a VS/TS of 80% and an energy content of 8,960 BTU/lb DM. The dewatered biosolids 4 (88,675 gallons per day (GPD) or 370 short tonnes per day (TPD)) was sent to a 360 cubic yard cake storage unit 6. Screw conveyor 8 was used to transfer the biosolids 4 from the storage unit 6 to dryer 10, which had a drying capacity of 11 short tonnes per hour (TPH) and a heat demand of 37.6 MMBTU/hr. Natural gas provided 4.5 MMBTU/hr and recovered heat from the system 2, as described below, provided 33.1 MMBTU/hr. The dryer 10 produced dried biosolids having a solids content of 90% TS, and dryer exhaust 14, which was sent to a three-stage scrubber 20.

The dried biosolids 12 (103 TPD) was sent to dried biosolids storage 22 before being sent to pyrolysis reactor 28. The pyrolysis reactor 28 had a pyrolysis capacity of 4.3 TPH, and produced syngas 32, biochar 30, and burner exhaust 34. Natural gas provided 9.9 MMBTU/hr of heat to the pyrolysis reactor 28. Produced biochar 30 (37.5 TPD) had a solids content of 100% TS, an energy content of 4,782 BTU/lb DM, and a reduced content of PFAS and/or CECs. The biochar 30 was stored in a 250 cubic yard storage unit 31, and then hauled off site 26.

The burner exhaust 34 was sent to heat exchanger 36, which provided 2.5 MMBTU/hr of heat to air 38 from the dryer 10 that flowed through the heat exchanger 36 and returned to the dryer 10. Cooled burner exhaust 40 was sent to a stack.

The syngas 32 was sent to thermal oxidizer 42. The thermal oxidizer 42 produced oxidizer exhaust 44 comprising carbon dioxide, water vapor, and hydrogen fluoride. The oxidizer exhaust 44 was sent to heat exchanger 50, which provided 29 MMBTU/hr of heat to oil 52 from the dryer 10 that flowed through the heat exchanger 50 and returned to the dryer 10. Cooled oxidizer exhaust 54 was sent to NOx treatment unit 56. Following NOx treatment, the treated exhaust was sent to heat exchanger 58, which provided 1.5 MMBTU/hr of heat to water 60 from the dryer 10 that flowed through the heat exchanger 58 and returned to the dryer 10. Cooled treated exhaust was sent to SOx treatment unit 62, and following treatment, the exhaust 40 was sent to a stack.

### Example 4

In another example of a system 2 as described above, dried biosolids 12 to be fed into pyrolysis reactor 28 having a solids content of 93% TS was compared to biochar 30 having a solids content of 99% TS produced by pyrolysis of dried biosolids 12. The pyrolysis was conducted at a temperature of 510 degrees C. and a residence time of 30 minutes. The proximate analysis of the dried biosolids 12 and the biochar 30 are shown in Table 1. In Table 2, the nitrogen, phosphorus, potassium, and sulfur content of the dried biosolids 12 and the biochar 30 are compared. Tables 3 and 4 show a reduction of PFAS compounds in the biochar 30 compared to dried biosolids 12. Table 5 shows a reduction of CECs in the biochar 30 compared to dried biosolids 12.

TABLE 1
Proximate analysis for dried biosolids and pyrolysis biochar

| | | Wastewater | |
|---|---|---|---|
| | | Treatment Plant | Pyrolysis |
| Parameter | Unit | Dried Biosolids | Biochar Product |
| Moisture | % dw¹ | 7.2 | 0.25 |
| Ash | % dw | 27.6 | 65 |
| Volatile Matter | % dw | 61.8 | 33.9 |
| Fixed Carbon | % dw | 3.4 | 0.9 |
| Heat Value | BTU/lb | 6973 | 4969 |
| pH | — | 6.70 | 6.98 |

¹% dw = % dry weight basis.

TABLE 2
N, P, K and S analysis for dried biosolids and pyrolysis biochar

| | | Wastewater | Pyrolysis |
|---|---|---|---|
| | Detection | Treatment Plant | Biochar |
| | Limit | Dried Biosolids | Product |
| Parameter | (% dw) | (% dw) | (% dw) |
| Total Nitrogen (N) | 0.01 | 5.89 | 1.85 |
| Carbon Nitrogen Ratio | — | 6.1 | 21.1 |
| (C/N) | | | |
| Ammoniacal Nitrogen | 0.01 | 0.24 | ND |
| (N) | | | |
| Nitrate Nitrogen (N) | 0.01 | ND | ND |
| Total Phosphate (P₂O₅) | 0.1 | 6.48 | 16.9 |
| Potash (K₂O) | 0.1 | 0.24 | 0.47 |
| Soluble Potash (K₂O) | 0.01 | 0.24 | 0.47 |
| Sulfur | 0.05 | 2.1 | 1.66 |

1. % dw = % dry weight basis.

TABLE 3
Per- and polyfluoroalkyl substances (PFAS)
in dried biosolids and pyrolysis biochar

| | | | Wastewater | Pyrolysis |
|---|---|---|---|---|
| | | Detection | Treatment Plant | Biochar |
| | | Limit | Dried Biosolids | Product |
| Analyte | CAS | (ng/g) | (ng/g) | (ng/g) |
| PFBA | 375-22-4 | 2.00 | ND¹ | ND |
| PFPeA | 2706-90-3 | 2.00 | ND | ND |
| PFBS | 375-73-5 | 2.00 | ND | ND |
| 4:2 FTS | 757124-72-4 | 2.00 | ND | ND |
| PFHxA | 307-24-4 | 2.00 | 5.53 | ND |
| PFPeS | 2706-91-4 | 2.00 | ND | ND |
| PFHpA | 375-85-9 | 2.00 | ND | ND |
| PFHxS | 355-46-4 | 2.00 | ND | ND |
| 6:2 FTS | 27619-97-2 | 2.00 | ND | ND |
| PFOA | 335-67-1 | 2.00 | 2.92 | ND |
| PFHpS | 375-92-8 | 2.00 | ND | ND |
| PFNA | 375-95-1 | 2.00 | ND | ND |
| PFOSA | 754-91-6 | 2.00 | ND | ND |
| PFOS | 1763-23-1 | 2.00 | 3.47 | ND |
| PFDA | 335-76-2 | 2.00 | ND | ND |
| 8:2 FTS | 39108-34-4 | 2.00 | ND | ND |
| MeFOSAA | 2355-31-9 | 2.00 | 3.14 | ND |
| EtFOSAA | 2991-50-6 | 2.00 | ND | ND |
| PFUnA | 2058-94-8 | 2.00 | ND | ND |
| PFDS | 335-77-3 | 2.00 | ND | ND |
| PFDOA | 307-55-1 | 2.00 | ND | ND |
| PFTrDA | 72629-94-8 | 2.00 | ND | ND |
| PFTeDA | 376-06-7 | 2.00 | ND | ND |

¹ND = not detected, below detection limit. All results on a dry weight basis.

TABLE 4
Per- and polyfluoroalkyl substances (PFAS) in dried biosolids and pyrolysis biochar

| | | | | Biochar | Biochar | Biochar | | Biochar |
|---|---|---|---|---|---|---|---|---|
| | | Detection | Biosolid | 1000° F. | 950° F. | 650° F. | | 700° F. |
| | | Limit | Pellets | 120 min¹ | 30 min | 30 min | Cake | 30 min |
| Analyte | CAS | (ng/g) | (ng/g) | (ng/g) | (ng/g) | (ng/g) | (ng/g) | (ng/g) |
| PFBA | 375-22-4 | 2.00 | ND² | ND | ND | ND | 3.80 | ND |
| PFPeA | 2706-90-3 | 2.00 | ND | ND | ND | ND | 2.59 | ND |
| PFBS | 375-73-5 | 2.00 | ND | ND | ND | ND | 3.88 | 3.14 |
| 4:2 FTS | 757124-72-4 | 2.00 | ND | ND | ND | ND | ND | ND |
| PFHxA | 307-24-4 | 2.00 | 5.53 | ND | ND | ND | 7.62 | ND |
| PFPeS | 2706-91-4 | 2.00 | ND | ND | ND | ND | ND | ND |
| PFHpA | 375-85-9 | 2.00 | ND | ND | ND | ND | ND | ND |
| PFHxS | 355-46-4 | 2.00 | ND | ND | ND | ND | ND | ND |
| 6:2 FTS | 27619-97-2 | 2.00 | ND | ND | ND | ND | 3.47 | 3.24 |
| PFOA | 335-67-1 | 2.00 | 2.92 | ND | ND | ND | 4.98 | ND |
| PFHpS | 375-92-8 | 2.00 | ND | ND | ND | ND | ND | ND |
| PFNA | 375-95-1 | 2.00 | ND | ND | ND | ND | ND | ND |
| PFOSA | 754-91-6 | 2.00 | ND | ND | ND | ND | ND | ND |
| PFOS | 1763-23-1 | 2.00 | 3.47 | ND | ND | ND | 10.20 | 12.60³ |
| PFDA | 335-76-2 | 2.00 | ND | ND | ND | ND | 2.64 | ND |
| 8:2 FTS | 39108-34-4 | 2.00 | ND | ND | ND | ND | 2.09 | 2.08 |
| MeFOSAA | 2355-31-9 | 2.00 | 3.14 | ND | ND | ND | 2.52 | 3.77 |
| EtFOSAA | 2991-50-6 | 2.00 | ND | ND | ND | ND | ND | 2.01 |
| PFUnA | 2058-94-8 | 2.00 | ND | ND | ND | ND | ND | ND |
| PFDS | 335-77-3 | 2.00 | ND | ND | ND | ND | ND | ND |
| PFDoA | 307-55-1 | 2.00 | ND | ND | ND | ND | ND | ND |
| PFTrDA | 72629-94-8 | 2.00 | ND | ND | ND | ND | ND | ND |
| PFTeDA | 376-06-7 | 2.00 | ND | ND | ND | ND | ND | ND |

¹1000° F. refers to the pyrolysis temperature, and 120 min refers to the retention time.
²ND = not detected above detection limit.
³Higher concentrations in the biochar are the result of concentration of solids (e.g., 50% wt biochar yield) along with partial destruction.

TABLE 5
Contaminants of Emerging Concern (CECs)
in dried biosolids and pyrolysis biochar

| | | Wastewater | |
|---|---|---|---|
| | Detection | Treatment Plant | Pyrolysis |
| | Limit | Dried Biosolids | Biochar Product |
| Analyte | (ng/g) | (ng/g) | (ng/g) |
| 2-hydroxy-ibuprofen | 4.0 | 48.6 | ND¹ |
| 4-nonylphenol | 900 | 164250 | ND |
| Bisphenol A | 6.0 | 1760 | ND |
| Carbamazepine | 0.02 | 24.0 | ND |
| Estrogen | 22.5 | 31.4 | ND |
| Furosemide | 4.0 | 9.4 | ND |
| Gemfibrozil | 0.8 | 35.0 | ND |
| Glipizide | 0.8 | ND | ND |
| Glyburide | 0.8 | ND | ND |
| Hydrochlorothiazide | 8.5 | 11.6 | ND |
| Ibuprofen | 4.0 | 121 | ND |
| Naproxen | 2.0 | 25.5 | ND |
| Sulfamethoxazole | 0.03 | 0.3 | ND |
| Triclocarban | 0.4 | 207 | ND |
| Triclosan | 6.0 | 2310 | ND |
| Trimethoprim | 0.02 | 2.6 | ND |
| Warfarin | 0.4 | ND | ND |

¹ND = not detected. Below detection limit. All results on a dry weight basis.

### Example 5

In another example of a system 2 as described above, the thermal oxidizing parameters are provided in Table 6.

TABLE 6
Thermal oxidizer parameters

| Thermal Oxidizer | Dual-Stage Combustion |
|---|---|
| Operating Temperature | Stage 1 Outlet: 2,250° F. |
| | Stage 2 Outlet: 1,650° F. |
| | Heat Exchanger Outlet: 750° F. |
| Retention Time | >1 second (nominal) |
| Destruction Efficiency | >99% of VOC (or ≤20 ppm) |
| Combustion Blower | 15 HP |
| 480 V/3 Ph/60 Hz TEFC | |
| Recycle Flue Gas Blower | 150 HP |
| 480 V/3 Ph/60 Hz TEFC | (designed for 750° F.) |
| Specially Designed Process | |
| Burner - Low NOx | |
| Maximum Heat Release | 27.0 MMBTU/H |
| Minimum Heat Release (pilot) | 0.25 MMBTU/H |
| Maximum Firing during Start-Up | 12.0 MMBTU/H |
| | (8:1 Turn Down) |
| Estimated Footprint | 15′ × 40′ |

### Example 6

In another example of a system 2 as described above, undigested wastewater sludge was pyrolyzed and thermally oxidized. Tables 7-9 show a reduction of CECs in the biochar 30 compared to biosolids 12.

TABLE 7
Pharmaceutical contaminants in biosolids and pyrolysis biochar
SAMPLE ANALYSIS SUMMARY

| | | | |
|---|---|---|---|
| Parameter | Units | Biosolids | Biochar |

Pharmaceutical Analysis

| | | | |
|---|---|---|---|
| Bisphenol A | ng/g | 1120 | ND |
| Furosemide | ng/g | 13 | ND |
| Gemfibrozil | ng/g | 248 | ND |
| Glipizide | ng/g | ND | ND |
| Glyburide | ng/g | ND | ND |
| Hydrochlorothiazide | ng/g | ND | ND |
| 2-Hydroxy-ibuprofen | ng/g | 31.7 | ND |
| Ibuprofen | ng/g | 26.8 | ND |
| Naproxen | ng/g | 117 | ND |
| Triclocarban | ng/g | 150 | ND |
| Triclosan | ng/g | 403 | ND |
| Warfarin | ng/g | ND | ND |
| Acetaminophen | ng/g | 621 | ND |
| Azithromycin | ng/g | 1490 | ND |
| Caffeine | ng/g | 817 | ND |
| Carbadox | ng/g | ND | ND |
| Carbamazepine | ng/g | 9.65 | ND |
| Cefotaxime | ng/g | ND | ND |
| Ciprofloxacin | ng/g | 1240 | ND |
| Clarithromycin | ng/g | 66.3 | ND |
| Clinafloxacin | ng/g | ND | ND |
| Cloxacillin | ng/g | ND | ND |
| Dehydronifedipine | ng/g | 11.6 | ND |
| Diphenhydramine | ng/g | 1810 | ND |
| Diltiazem | ng/g | 596 | ND |
| Digoxin | ng/g | 35.7 | ND |
| Digoxigenin | ng/g | ND | ND |
| Enrofloxacin | ng/g | ND | ND |
| Erythromycin-H2O | ng/g | 7.25 | ND |
| Flumequine | ng/g | ND | ND |
| Fluoxetine | ng/g | 80.1 | ND |
| Lincomycin | ng/g | ND | ND |
| Lomefloxacin | ng/g | 20 | ND |
| Miconazole | ng/g | 593 | ND |
| Norfloxacin | ng/g | ND | ND |
| Norgestimate | ng/g | ND | ND |
| Ofloxacin | ng/g | 747 | ND |
| Ormetoprim | ng/g | ND | ND |
| Oxacillin | ng/g | ND | ND |
| Oxolinic Acid | ng/g | ND | ND |
| Penicillin G | ng/g | ND | ND |
| Penicillin V | ng/g | ND | ND |
| Roxithromycin | ng/g | ND | ND |
| Sarafloxacin | ng/g | ND | ND |
| Sulfachloropyridazine | ng/g | ND | ND |
| Sulfadiazine | ng/g | 4.11 | ND |
| Sulfadimethoxine | ng/g | ND | ND |
| Sulfamerazine | ng/g | ND | ND |
| Sulfamethazine | ng/g | ND | ND |
| Sulfamethizole | ng/g | ND | ND |
| Sulfamethoxazole | ng/g | 14.3 | ND |
| Sulfanilamide | ng/g | ND | ND |
| Sulfathiazole | ng/g | ND | ND |
| Thiabendazole | ng/g | 27.9 | ND |
| Trimethoprim | ng/g | 27.5 | ND |
| Tylosin | ng/g | ND | ND |
| Virginiamycin M1 | ng/g | ND | ND |
| 1,7-Dimethylxanthine | ng/g | 612 | ND |

ND = not detected. Below detection limit.

TABLE 8
Contaminants of Polycyclic Aromatic Hydrocarbons
(PAHs) in biosolids and pyrolysis biochar
SAMPLE ANALYSIS SUMMARY

| | | | |
|---|---|---|---|
| Parameter | Units | Biosolids | Biochar |

PAH Analysis

| | | | |
|---|---|---|---|
| Acenaphthylene | ng/g | 7.03 | 1.03 |
| Acenaphthene | ng/g | 25.7 | 5.45 |
| Fluorene | ng/g | 37.3 | 1.81 |
| Phenanthrene | ng/g | 452 | 18 |
| Anthracene | ng/g | 90.3 | 2.79 |
| Fluoranthene | ng/g | 541 | 3.5 |
| Pyrene | ng/g | 530 | 5.04 |
| Benz[a]anthracene | ng/g | 193 | 1.3 |
| Chrysene | ng/g | 284 | 2.23 |
| Benzo[b]fluoranthene | ng/g | 248 | 1.05 |
| Benzo[j,k]fluoranthenes | ng/g | 190 | 0.456 |
| Benzo[e]pyrene | ng/g | 218 | 1.42 |
| Benzo[a]pyrene | ng/g | 217 | 1.32 |
| Perylene | ng/g | 62.9 | ND |
| Dibenz[a,h]anthracene | ng/g | 42.4 | 0.375 |
| Indeno[1,2,3-cd]pyrene | ng/g | 166 | 1.24 |
| Benzo[ghi]perylene | ng/g | 200 | 1.48 |
| 2-Methylnaphthalene | ng/g | 35.5 | 26.4 |
| 2,6-Dimethylnaphthalene | ng/g | 31.3 | 4.53 |
| 2,3,5-Trimethylnaphthalene | ng/g | 61.5 | 1.86 |
| 1-Methylphenanthrene | ng/g | 55.6 | 1.19 |
| Dibenzothiophene | ng/g | 30 | 1.59 |

ND = not detected. Below detection limit.

TABLE 9
Contaminants of Polychlorinated Biphenyls
(PCBs) in biosolids and pyrolysis biochar
SAMPLE ANALYSIS SUMMARY

| | | | |
|---|---|---|---|
| Parameter | Units | Biosolids | Biochar |

PCB Analysis

| | | | |
|---|---|---|---|
| PCB-1 | pg/g | 99 | 1.61 |
| PCB-2 | pg/g | 141 | 1.42 |
| PCB-3 | pg/g | 73.8 | 1.97 |
| PCB-4 | pg/g | 904 | 4.11 |
| PCB-5 | pg/g | 31.9 | 0.345 |
| PCB-6 | pg/g | 397 | 5.15 |
| PCB-7 | pg/g | 45.9 | 0.913 |
| PCB-8 | pg/g | 1190 | 9.51 |
| PCB-9 | pg/g | 188 | 0.929 |
| PCB-10 | pg/g | 37.5 | 0.225 |
| PCB-11 | pg/g | 1590 | 154 |
| PCB-12 + 13 | pg/g | 144 | 3.87 |
| PCB-14 | pg/g | 2.21 | ND |
| PCB-15 | pg/g | 545 | 3.97 |
| PCB-16 | pg/g | 1330 | 4.61 |
| PCB-17 | pg/g | 1210 | 4.97 |
| PCB-18 + 30 | pg/g | 1560 | 9.26 |
| PCB-19 | pg/g | 470 | 1.16 |
| PCB-20 + 28 | pg/g | 3260 | 11.8 |
| PCB-21 + 33 | pg/g | 1700 | 7.05 |
| PCB-22 | pg/g | 1280 | 3.98 |
| PCB-23 | pg/g | 5.95 | ND |
| PCB-24 | pg/g | 29.7 | 0.139 |
| PCB-25 | pg/g | 297 | 1.17 |
| PCB-26 + 29 | pg/g | 639 | 2.23 |
| PCB-27 | pg/g | 201 | 0.685 |
| PCB-31 | pg/g | 2300 | 10.2 |
| PCB-32 | pg/g | 394 | 2.92 |
| PCB-34 | pg/g | 13.6 | ND |
| PCB-35 | pg/g | 110 | 0.214 |
| PCB-36 | pg/g | 18.4 | ND |
| PCB-37 | pg/g | 712 | 2.68 |
| PCB-38 | pg/g | 1.86 | ND |
| PCB-39 | pg/g | 23.2 | ND |
| PCB-40 + 41 + 71 | pg/g | 2070 | 4.59 |
| PCB-42 | pg/g | 882 | 2.16 |
| PCB-43 | pg/g | 165 | 0.365 |
| PCB-44 + 47 + 65 | pg/g | 3940 | 83.4 |
| PCB-45 + 51 | pg/g | 904 | 16.4 |
| PCB-46 | pg/g | 254 | 0.679 |
| PCB-48 | pg/g | 772 | 1.9 |
| PCB-49 + 69 | pg/g | 2090 | 5.58 |
| PCB-50 + 53 | pg/g | 606 | 1.63 |
| PCB-52 | pg/g | 4570 | 11.8 |
| PCB-54 | pg/g | 48.9 | 0.131 |
| PCB-55 | pg/g | 49.7 | 0.171 |
| PCB-56 | pg/g | 1330 | 2.61 |
| PCB-57 | pg/g | 13.1 | ND |
| PCB-58 | pg/g | 4.78 | ND |
| PCB-59 + 62 + 75 | pg/g | 251 | 1.21 |
| PCB-60 | pg/g | 893 | 1.53 |
| PCB-61 + 70 + 74 + 76 | pg/g | 5770 | 10.7 |
| PCB-63 | pg/g | 118 | 0.194 |
| PCB-64 | pg/g | 1490 | 3.24 |
| PCB-66 | pg/g | 2520 | 4.62 |
| PCB-67 | pg/g | 82.2 | 0.208 |
| PCB-68 | pg/g | 37.3 | 4.8 |
| PCB-72 | pg/g | 15.9 | ND |
| PCB-73 | pg/g | ND | ND |
| PCB-77 | pg/g | 240 | 0.553 |
| PCB-78 | pg/g | 2.07 | ND |
| PCB-79 | pg/g | 45.4 | ND |
| PCB-80 | pg/g | ND | ND |
| PCB-81 | pg/g | 11.6 | ND |
| PCB-82 | pg/g | 661 | 1.2 |
| PCB-83 + 99 | pg/g | 2400 | 4.19 |
| PCB-84 | pg/g | 1540 | 2.44 |
| PCB-85 + 116 + 117 | pg/g | 899 | 1.42 |
| PCB-86 + 87 + 97 + 109 + 119 + 125 | pg/g | 3560 | 6.46 |
| PCB-88 + 91 | pg/g | 715 | 1.23 |
| PCB-89 | pg/g | 73.7 | ND |
| PCB-90 + 101 + 113 | pg/g | 4650 | 7.81 |
| PCB-92 | pg/g | 633 | 1.29 |
| PCB-93 + 95 + 98 + 100 + 102 | pg/g | 4250 | 6.81 |
| PCB-94 | pg/g | 37.5 | ND |
| PCB-96 | pg/g | 45.5 | ND |
| PCB-103 | pg/g | 33.7 | ND |
| PCB-104 | pg/g | 9.83 | ND |
| PCB-105 | pg/g | 1900 | 3.84 |
| PCB-106 | pg/g | ND | ND |
| PCB-107 | pg/g | 222 | 0.424 |
| PCB-108 + 124 | pg/g | 168 | 0.353 |
| PCB-110 + 115 | pg/g | 5130 | 9.6 |
| PCB-111 | pg/g | ND | ND |
| PCB-112 | pg/g | ND | ND |
| PCB-114 | pg/g | 131 | 0.225 |
| PCB-118 | pg/g | 4150 | 8.56 |
| PCB-120 | pg/g | 4.1 | ND |
| PCB-121 | pg/g | 7.3 | ND |
| PCB-122 | pg/g | 54.6 | ND |
| PCB-123 | pg/g | 101 | 0.184 |
| PCB-126 | pg/g | 8.15 | ND |
| PCB-127 | pg/g | 8.67 | ND |
| PCB-128 + 166 | pg/g | 758 | 1.51 |
| PCB-129 + 138 + 160 + 163 | pg/g | 4300 | 8.35 |
| PCB-130 | pg/g | 270 | 0.423 |
| PCB-131 | pg/g | 74.7 | 0.12 |
| PCB-132 | pg/g | 1590 | 3.01 |
| PCB-133 | pg/g | 55.4 | 0.147 |
| PCB-134 + 143 | pg/g | 261 | 0.427 |
| PCB-135 + 151 + 154 | pg/g | 922 | 2.19 |
| PCB-136 | pg/g | 611 | 0.944 |
| PCB-137 | pg/g | 293 | 0.544 |
| PCB-139 + 140 | pg/g | 86.6 | 0.112 |
| PCB-141 | pg/g | 748 | 1.48 |
| PCB-142 | pg/g | ND | ND |
| PCB-144 | pg/g | 196 | 0.271 |
| PCB-145 | pg/g | 3.23 | ND |
| PCB-146 | pg/g | 464 | 1.1 |
| PCB-147 + 149 | pg/g | ND | 5.29 |
| PCB-148 | pg/g | 8.98 | ND |
| PCB-150 | pg/g | 11 | ND |
| PCB-152 | pg/g | 6.02 | ND |
| PCB-153 + 168 | pg/g | 3200 | 6 |
| PCB-155 | pg/g | 82.2 | 0.176 |
| PCB-156 + 157 | pg/g | 605 | 1.11 |
| PCB-158 | pg/g | 439 | 0.918 |
| PCB-159 | pg/g | ND | ND |
| PCB-161 | pg/g | ND | ND |
| PCB-162 | pg/g | 11.1 | ND |
| PCB-164 | pg/g | 253 | 0.501 |
| PCB-165 | pg/g | ND | ND |
| PCB-167 | pg/g | 174 | 0.378 |
| PCB-169 | pg/g | ND | ND |
| PCB-170 | pg/g | 698 | 1.4 |
| PCB-171 + 173 | pg/g | 230 | 0.474 |
| PCB-172 | pg/g | 36.5 | 0.255 |
| PCB-174 | pg/g | 727 | 1.39 |
| PCB-175 | pg/g | 31.4 | ND |
| PCB-176 | pg/g | 99.6 | 0.145 |
| PCB-177 | pg/g | 397 | 0.812 |
| PCB-178 | pg/g | 150 | 0.161 |
| PCB-179 | pg/g | 316 | 0.527 |
| PCB-180 + 193 | pg/g | 1680 | 3.35 |
| PCB-181 | pg/g | 10.8 | ND |
| PCB-182 | pg/g | ND | ND |
| PCB-183 + 185 | pg/g | 505 | 1.04 |
| PCB-184 | pg/g | 69.8 | 0.211 |
| PCB-186 | pg/g | 0.434 | ND |
| PCB-187 | pg/g | 889 | 1.7 |
| PCB-188 | pg/g | 2.56 | ND |
| PCB-189 | pg/g | 28.4 | 0.105 |
| PCB-190 | pg/g | 147 | 0.273 |
| PCB-191 | pg/g | 26.5 | ND |
| PCB-192 | pg/g | ND | ND |
| PCB-194 | pg/g | 338 | 0.757 |
| PCB-195 | pg/g | 103 | 0.198 |
| PCB-196 | pg/g | 170 | 0.3 |
| PCB-197 + 200 | pg/g | 61.3 | 0.161 |
| PCB-198 + 199 | pg/g | 519 | 0.978 |
| PCB-201 | pg/g | 58.9 | 0.164 |
| PCB-202 | pg/g | 118 | 0.258 |
| PCB-203 | pg/g | 316 | 0.565 |
| PCB-204 | pg/g | 5.59 | ND |
| PCB-205 | pg/g | 16.3 | ND |
| PCB-206 | pg/g | 348 | 0.501 |
| PCB-207 | pg/g | 37.9 | ND |
| PCB-208 | pg/g | 112 | 0.178 |
| PCB-209 | pg/g | 166 | 0.409 |
| Total Monochloro Biphenyls | pg/g | 314 | 5 |
| Total Dichloro Biphenyls | pg/g | 5080 | 179 |
| Total Trichloro Biphenyls | pg/g | 15600 | 61.6 |
| Total Tetrachloro Biphenyls | pg/g | 29200 | 157 |
| Total Pentachloro Biphenyls | pg/g | 31400 | 51.2 |
| Total Hexachloro Biphenyls | pg/g | 18500 | 30.1 |
| Total Heptachloro Biphenyls | pg/g | 6040 | 10.6 |
| Total Octachloro Biphenyls | pg/g | 1710 | 0.258 |
| Total Nonachloro Biphenyls | pg/g | 498 | 0.501 |
| Decachloro Biphenyl | pg/g | 166 | 0.409 |
| TOTAL PCBs | pg/g | 108000 | 496 |
| Aroclor 1016 | pg/g | ND | ND |
| Aroclor 1221 | pg/g | ND | ND |
| Aroclor 1232 | pg/g | ND | ND |
| Aroclor 1242 | pg/g | 24900 | 122 |
| Aroclor 1248 | pg/g | ND | ND |
| Aroclor 1254 | pg/g | 47700 | 51.7 |
| Aroclor 1260 | pg/g | 14400 | 29 |
| 2,3,7,8-TCDD | pg/g | ND | ND |
| 1,2,3,7,8-PECDD | pg/g | ND | ND |
| 1,2,3,4,7,8-HXCDD | pg/g | 0.769 | ND |
| 1,2,3,6,7,8-HXCDD | pg/g | 2.79 | ND |
| 1,2,3,7,8,9-HXCDD (225) | pg/g | 1.57 | ND |
| 1,2,3,7,8,9-HXCDD | pg/g | 2.38 | ND |
| 1,2,3,4,6,7,8-HPCDD | pg/g | 95.4 | ND |
| OCDD | pg/g | 1790 | ND |
| 2,3,7,8-TCDF (225) | pg/g | 0.963 | ND |
| 2,3,7,8-TCDF | pg/g | 2.57 | ND |
| 1,2,3,7,8-PECDF | pg/g | 0.405 | ND |
| 2,3,4,7,8-PECDF | pg/g | 0.647 | ND |
| 1,2,3,4,7,8-HXCDF | pg/g | ND | ND |
| 1,2,3,6,7,8-HXCDF | pg/g | 1.26 | ND |
| 1,2,3,7,8,9-HXCDF | pg/g | ND | ND |
| 2,3,4,6,7,8-HXCDF | pg/g | 0.849 | ND |
| 1,2,3,4,6,7,8-HPCDF | pg/g | 20.9 | ND |
| 1,2,3,4,7,8,9-HPCDF | pg/g | 1.08 | ND |
| OCDF | pg/g | 42.8 | ND |
| TOTAL TETRA-DIOXINS | pg/g | 5.69 | ND |
| TOTAL PENTA-DIOXINS | pg/g | 10.9 | ND |
| TOTAL HEXA-DIOXINS | pg/g | 27.6 | ND |
| TOTAL HEPTA-DIOXINS | pg/g | 193 | ND |
| TOTAL TETRA-FURANS | pg/g | 10.7 | ND |
| TOTAL PENTA-FURANS | pg/g | 12.6 | ND |
| TOTAL HEXA-FURANS | pg/g | 16 | ND |
| TOTAL HEPTA-FURANS | pg/g | 38 | ND |

ND = not detected. Below detection limit.

Unless stated otherwise or apparent from the context, solids contents or concentrations mentioned above are total solids (TS) measurements, which would be the same as a dried solids (DS) measurement. In digestate, the DS is roughly 10% higher than total suspended solids (TSS) and the total dissolved solids (TDS) is typically 2500 to 4000 mg/L (0.25 to 0.4%). For example, a 5% DS digestate may have 46,000 mg/L of TSS and 4000 mg/L TDS. Accordingly, solids contents or concentrations, unless specified otherwise, can generally be interpreted as TSS without causing a material difference in the process.

The descriptions of processes and apparatus above are to provide at least one example of an embodiment within each claim but not to limit or define any claim. However, multiple processes and apparatus have been described above and it is possible that a particular process or apparatus described above is not within a specific claim. Process parameters are given as examples of how a plant may be operated and are not meant to limit a claim unless explicitly recited in a claim. Other processes for similar applications might operate at parameters within ranges that are 50% or 100% larger in both directions than the parameter ranges described above, or within a 50% or 100% variation from a single parameter described above. If one or more elements or steps described above are used to treat other wastes or under other conditions, then one or more process ranges described above might not be suitable and would be substituted with other appropriate parameters. Words such as “may”, “preferable” or “typical”, or variations of them in the description above, indicate that a process step or apparatus element is possible, preferable or typical, according to the word used, but still optional and not necessarily part of any claimed invention unless explicitly included in a claim.

What is claimed is:

1. A process for treating organic waste, comprising the steps of
volatizing at least a portion of the organic waste; and
oxidizing the gas.

2. The process of claim 1, wherein the volatizing step comprises pyrolysing and/or gasifying the at least a portion of the organic waste.

3. The process of claim 1 or 2, wherein the volatizing step comprises volatizing Perfluoroalkyl substances (PFAS) compounds and/or Contaminants of Emerging Concern (CECs), such as pharmaceutical contaminants, Polychlorinated Biphenyls (PCBs), and Polycyclic Aromatic Hydrocarbons (PAHs), from the organic waste.

4. The process of any one of claims 1-3, wherein the temperature of the volatizing step is from about 300 to about 850 degrees C.

5. The process of any one of claims 1-4, wherein the volatizing step is conducted at a residence time of from about 10 to about 90 minutes.

6. The process of any one of claims 1-5, wherein the temperature of the oxidizing step is from about 700 to about 1350 degrees C.

7. The process of any one of claims 1-6, wherein the oxidizing step is conducted at a residence time from about 0.1 to about 10.0 seconds.

8. The process of any one of claims 1-6, wherein the biochar portion produced in the volatizing step has a PFAS compound content of less than about 6 ng/g, less than about 4 ng/g, less than about 3 ng/g, less than about 2 ng/g, below detection limits, or less than about 2.5 ppb (PFOA) and/or less than about 5.2 ppb (PFOS).

9. The process of any one of claims 1-7, wherein the biochar portion produced in the volatizing step has a Perfluoroalkyl substances (PFAS) compound and/or Contaminants of Emerging Concern (CECs), such as pharmaceutical contaminants, Polychlorinated Biphenyls (PCBs), and Polycyclic Aromatic Hydrocarbons (PAHs) content reduced by about 75%, about 80%, about 85%, about 90%, about 95%, about 97%, about 98%, about 99%, or 100% in comparison to the Perfluoroalkyl substances (PFAS) compound and/or Contaminants of Emerging Concern (CECs), such as pharmaceutical contaminants, Polychlorinated Biphenyls (PCBs), and Polycyclic Aromatic Hydrocarbons (PAHs) content before the volatizing step.

10. The process of any one of claims 1-9, wherein the biochar or char portion produced in the volatizing step is a class A biosolid.

11. The process of any one of claims 1-10, further comprising recovering energy from the flue gas produced from the oxidation step.

12. The process of any one of claims 1-11, wherein the organic waste comprises wastewater treatment primary or secondary sludge, source separated organics (SSO), food waste, the organic fraction of municipal solid waste, yard waste, industrial or commercial waste, or agricultural waste, or any combination thereof.

13. The process of any one of claims 1-10, wherein organic waste comprises biosolids.

14. The process of claim 12 or 13, wherein the process further comprises drying the biosolids before the volatizing step.

15. The process of claim 14, wherein the dried biosolids comprises from about 15 ppb to about 30 ppb of PFAS compounds.

16. The process of claim 14 or 15, further comprising exchanging heat from the flue gas produced during the oxidation step.

17. The process of claim 16, further comprising using the exchanged heat for volatizing the organic waste and/or for drying the biosolids.

18. The process of any one of claims 1-17, further comprising treating the flue gas produced during the oxidation step to remove NOx and/or SOx.

19. The process of claim 18, further comprising exchanging heat between removing NOx and SOx.

20. A system for treating organic waste, comprising:
a volatilization reactor; and
a thermal oxidizer.

21. The system of claim 20, wherein the volatilization reactor is a pyrolysis reactor or a gasification reactor.

22. The system of claim 20 or 21, wherein the volatilization reactor has an outlet and the thermal oxidizer has an inlet, and wherein the outlet of the volatilization reactor is connected to the inlet of the thermal oxidizer.

23. The system of any one of claims 20-22, wherein the thermal oxidizer receives gas from the volatilization reactor.

24. The system of any one of claims 20-23, further comprising a dryer in communication with the volatilization reactor.

25. The system of any one of claims 20-24, further comprising a heat exchanger in thermal communication with the thermal oxidizer.

26. The system of claim 24 or 25, wherein the heat exchanger is in thermal communication with the dryer.

27. The system of any one of claims 24-26, wherein the heat exchanger is in thermal communication with the volatilization reactor.

28. The system of any one of claims 24-27, further comprising a second heat exchanger in thermal communication with the volatilization reactor and the dryer.

29. The system of any one of claims 20-28, further comprising a gas treatment unit, for example, a NOx and/or a SOx treatment unit, in communication with the thermal oxidizer.

30. The system of claim 29, further comprising a heat exchanger in thermal communication with the NOx and/or SOx treatment unit, for example, between the NOx and SOx treatment units.

31. The system of any one of claims 20-30, wherein the volatilization reactor is capable of volatizing Perfluoroalkyl substances (PFAS) compounds and/or Contaminants of Emerging Concern (CECs), such as pharmaceutical contaminants, Polychlorinated Biphenyls (PCBs), and Polycyclic Aromatic Hydrocarbons (PAHs), from the organic waste.

32. The system of any one of claims 20-31, wherein the biochar portion produced in the volatilization reactor has a Perfluoroalkyl substances (PFAS) compound and/or Contaminants of Emerging Concern (CECs), such as pharmaceutical contaminants, Polychlorinated Biphenyls (PCBs), and Polycyclic Aromatic Hydrocarbons (PAHs) content reduced by about 75%, about 80%, about 85%, about 90%, about 95%, about 97%, about 98%, about 99%, or 100% in comparison to the Perfluoroalkyl substances (PFAS) compound and/or Contaminants of Emerging Concern (CECs), such as pharmaceutical contaminants, Polychlorinated Biphenyls (PCBs), and Polycyclic Aromatic Hydrocarbons (PAHs) content before volatilization.

33. A process for treating organic waste, comprising the steps of
oxidizing a volatized portion of organic waste.

34. The process of claim 33, wherein the volatized portion comprises Perfluoroalkyl substances (PFAS) compounds and/or Contaminants of Emerging Concern (CECs), such as pharmaceutical contaminants, Polychlorinated Biphenyls (PCBs), and Polycyclic Aromatic Hydrocarbons (PAHs), from the organic waste.
